(19) United States
(12) Patent Application Publication
(10) Pub. No.: US 2015/0124486 A1
(43) Pub. Date: May 7, 2015

(54) HANGING ACCESSORY FOR NIGHT LIGHTING

(71) Applicant: Ting Kwan William Chiu, Hong Kong (HK)

(72) Inventor: Ting Kwan William Chiu, Hong Kong (HK)

(21) Appl. No.: 14/534,133

(22) Filed: Nov. 5, 2014

(30) Foreign Application Priority Data
Nov. 6, 2013 (HK) 13112460.1

(51) Int. Cl. F21V 17/16; F21S 8/00; F21V 23/00; F21V 23/04

(52) U.S. Cl. CPC F21V 17/16; F21V 23/0471; F21S 8/035; F21V 23/004; F21Y 2101/02
USPC 362/642

(57) ABSTRACT

The present patent application provides a hanging accessory for night lighting. The hanging accessory includes a main body part which includes a front housing and a rear housing a clamping component mounted on the rear housing and a plurality of electrical elements.

### CROSS-REFERENCE TO RELATED APPLICATIONS

This application claims priority of Hong Kong Short-term Patent Application No. 13112460.1 filed on Nov. 6, 2013, the entire content of which is hereby incorporated by reference.

### TECHNICAL FIELD

The present patent application relates to an apparatus for night lighting, and in particular, to a hanging accessory for night lighting.

### BACKGROUND

During sleeping at night, a person may need to get up and turn on a lamp for some reasons, for example, going to the restroom or drinking water. In general, the person always turns on the lamp first, and then turns off the lamp and goes back to sleep after the activity is done. During this process, light from the lamp has strong stimulus to the person, which may sometimes make sleep suddenly disappear. Repetition of such a process will cause insomnia and a series of health problems, which are particularly serious for the old or the weak.

In order to facilitate night lighting, some small-sized nightlights are also available. Light of the nightlight is dimmer than that from a normal illuminating lamp. Some persons may keep the nightlights on for the whole night, which obviously may also disturb sleep. Some persons turn on the nightlights only when they get up for activities at night. However, since switches of the nightlights are generally installed in safe places, persons cannot always turn on or turn off the switches conveniently, which may cause a risk of falling for the weak or the old when they walk from beds to the switches.

### SUMMARY

The present patent application is directed to a hanging accessory for night lighting. The hanging accessory includes a main body part which includes a front housing and a rear housing a clamping component mounted on the rear housing and a plurality of electrical elements. The plurality of electrical elements includes a control circuit board, a power supply configured for supplying power, a capacitive human body induction sensor configured for sensing that a human body approaches the hanging accessory for night lighting, an environmental light intensity sensor configured for detecting an environmental light intensity, and a light emitting diode lamp configured for night lighting. A cavity for accommodating the plurality of electrical elements is formed between the front housing and the rear housing. The power supply, the capacitive human body induction sensor, the environmental light intensity sensor and light emitting diode lamp are connected to the control circuit board separately.

### BRIEF DESCRIPTION OF THE DRAWINGS

The present patent application is further described with reference to the accompanying drawings and embodiments, and in the accompanying drawings:

FIG. 1 is a first perspective view of a hanging accessory for night lighting according to an embodiment of the present patent application;

FIG. 2 is a second perspective view of a hanging accessory for night lighting according to the embodiment of the present patent application;

FIG. 3 is an exploded view of a hanging accessory for night lighting according to the embodiment of the present patent application;

FIG. 4 is a schematic diagram of a circuit of a hanging accessory for night lighting according to the embodiment of the present patent application; and

FIG. 5 is a schematic diagram of a power supply of a hanging accessory for night lighting according to the embodiment of the present patent application.

### DETAILED DESCRIPTION

To make the technical features, objectives, and effects of the present patent application easier to understand, specific implementation manners of the present patent application are described in detail with reference to the accompanying drawings.

Although the hanging accessory for night lighting is shown and described with respect to certain embodiments, it is obvious that equivalents and modifications will occur to others skilled in the art upon the reading and understanding of the specification. The hanging accessory for night lighting in the present application includes all such equivalents and modifications, and is limited only by the scope of the claims.

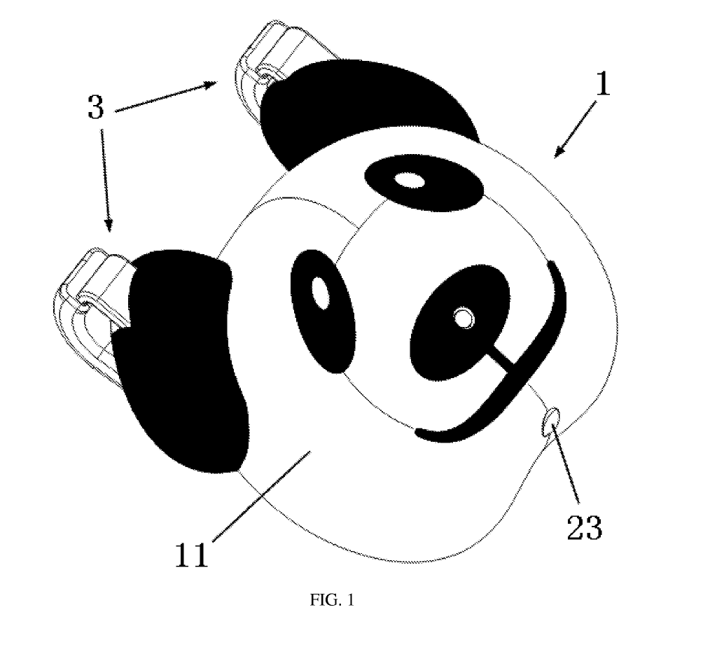

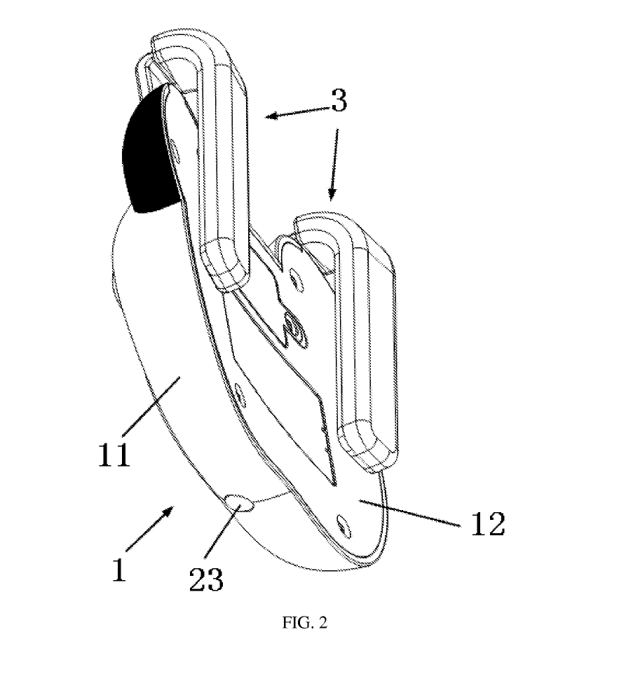

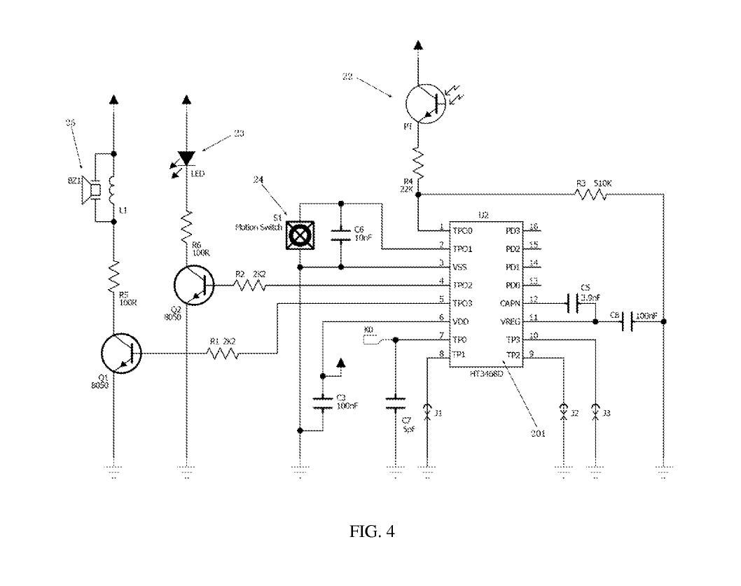

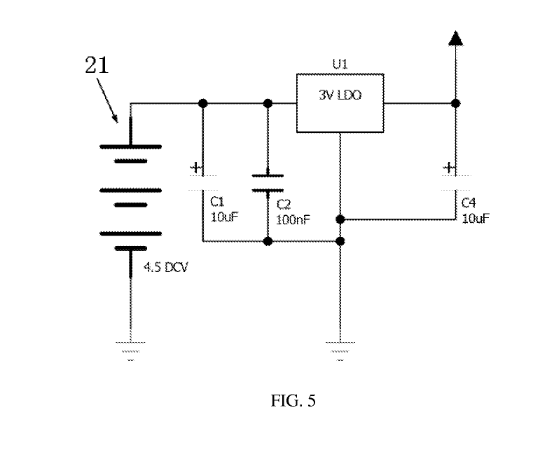

FIG. 1 to FIG. 5 illustrate an embodiment of a hanging accessory for night lighting according to the present patent application. The hanging accessory for night lighting of this embodiment is a hanging accessory having a cartoon panda head design. The hanging accessory includes a main body part 1 which is a cartoon panda head. The main body part 1 includes a front housing 11 and a rear housing 12. The front housing 11 and the rear housing 12 are fixed together by a connecting piece. A cavity for accommodating electrical elements is formed between the front housing 11 and the rear housing 12. A clamping component 3 is disposed on the rear housing 12, for clamping the hanging accessory on clothes, slippers, or other items. In this embodiment, two clamping components 3 are disposed on the rear housing 12. The clamping components 3 are clamps with elasticity. The hanging accessory can be conveniently fixed on other items by the clamps.

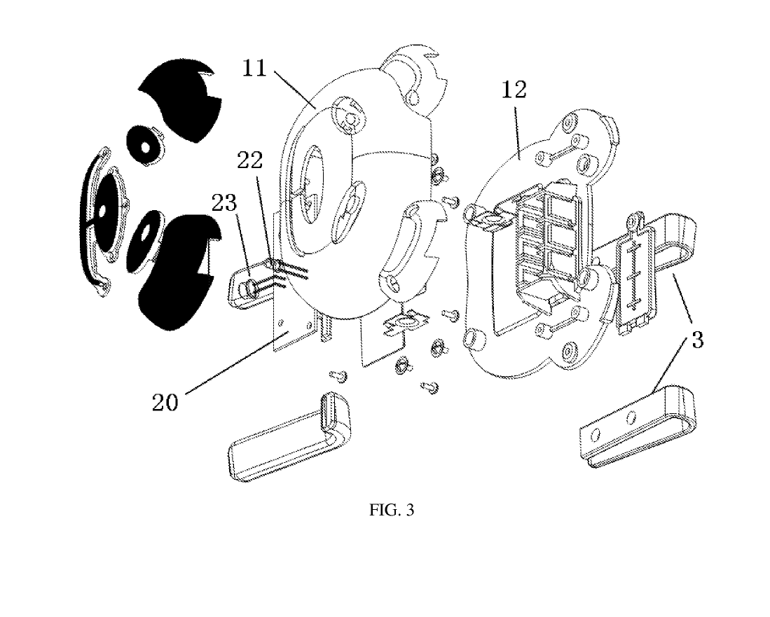

Referring to FIG. 3 to FIG. 5, in the present patent application, the electrical elements include a control circuit board 20. The electrical elements further include a power supply 21, a capacitive human body induction sensor, an environmental light intensity sensor 22, an LED lamp 23, a motion switch 24 and a beeping alarm 25, which are separately connected to the control circuit board 20. The control circuit board 20 is provided with a programmable control device, which may be a single chip microcomputer or a microprocessor. In this embodiment, the programmable control device is a single chip microcomputer 201. The power supply 21 is used for supplying power for the whole hanging accessory. In order to reduce a volume of the hanging accessory, the power supply 21 may use a button battery. The capacitive human body induction sensor is used for sensing that a human body approaches. The capacitive human body induction sensor has a metal induction sheet KO. Ground capacitance of the metal induction sheet KO changes when a human body approaches. The capacitive human body induction sensor detects and determines, according to a change of the ground capacitance of the metal induction sheet KO, whether a person approaches the hanging accessory. The environmental light intensity sensor 22 is used for detecting an environmental light intensity, so as to determine whether the hanging accessory is in darkness. The control circuit board 20 turns on the LED lamp 23 to provide lighting only when the hanging accessory is in darkness and a person is approaching the hanging accessory, for example, when the person puts on slippers or clothes. The LED lamp 23 is driven by a triode Q1. The motion switch 24 is used for detecting a situation where a human body falls, so as to prevent the problem that an old or weak person who gets up at night falls by accident and cannot get help from others. When the human body falls, it causes an impact on the hanging accessory, and at this time the motion switch 24 will be triggered. The beeping alarm 25 is used for alarming when the motion switch 24 is triggered, so as to achieve a function of alarming. Others can get to the site where the fall happens to provide assistance. In this embodiment, the beeping alarm is driven by a triode Q2. In this embodiment, in order to make the hanging accessory work better, the control circuit board 20 is further provided with an adjusting device for adjusting sensitivity of the capacitive human body induction sensor, so as to maintain appropriate sensitivity of the capacitive human body induction sensor, and prevent misjudgment.

In this embodiment, the environmental light intensity sensor 22 is a photoelectric triode, and may also be a photoresistor or another photoelectric element which can detect light intensity. In this embodiment, the LED lamp 23 uses a white LED, and may also use an LED lamp of another color as required.

In another embodiment, the motion switch and the beeping alarm can be omitted. In this case, the hanging accessory can only provide night lighting, but cannot achieve the function of alarming when a fall happens.

The hanging accessory for night lighting of the present patent application can have various cartoon designs, which may be an animal or a figure, and is not limited to the cartoon panda head design in this embodiment.

The hanging accessory for night lighting of the present patent application can be hung on clothes, or slippers and other items, which is convenient in use. Since a capacitive human body induction sensor is used, the hanging accessory for night lighting can sensitively and accurately sense that a human body approaches, provide lighting for a person who gets up at night in darkness, and at the same time will not stimulate the person. The hanging accessory for night lighting of the present patent application can also detect a fall of the human body, and alarm to seek assistance, which is particularly suitable for use by the old or the weak.

While the hanging accessory for night lighting has been shown and described with particular references to a number of preferred embodiments thereof, it should be noted that various other changes or modifications may be made without departing from the scope of the appended claims.

1. A hanging accessory for night lighting, comprising:
a main body part which comprises a front housing and a rear housing;
a clamping component mounted on the rear housing; and
a plurality of electrical elements comprising:
a control circuit board;
a power supply configured for supplying power;
a capacitive human body induction sensor configured for sensing that a human body approaches the hanging accessory for night lighting,
an environmental light intensity sensor configured for detecting an environmental light intensity,
a light emitting diode lamp configured for night lighting;
a motion switch configured for detecting a fall of a human body; and
a beeping alarm configured for alarming when the motion switch is triggered;
wherein a cavity for accommodating the plurality of electrical elements is formed between the front housing and the rear housing; and wherein the power supply, the capacitive human body induction sensor, the environmental light intensity sensor and light emitting diode lamp are connected to the control circuit board separately; and
wherein the control circuit board is provided with an adjusting device for adjusting sensitivity of the capacitive human body induction sensor.

2. The hanging accessory for night lighting according to claim 1, wherein the motion switch and the beeping alarm are connected to the control circuit board separately.

3. The hanging accessory for night lighting according to claim 1, wherein the main body part has a cartoon design.

4. The hanging accessory for night lighting according to claim 1, wherein the environmental light intensity sensor is a photoresistor.

5. The hanging accessory for night lighting according to claim 1, wherein the environmental light intensity sensor is a photoelectric triode.

6. The hanging accessory for night lighting according to claim 1, wherein the clamping component is a clamp with elasticity.

7. The hanging accessory for night lighting according to claim 1, wherein the LED lamp is a white LED.

8. A hanging accessory for night lighting, comprising:
a main body part which comprises a front housing and a rear housing;
a clamping component mounted on the rear housing; and
a plurality of electrical elements comprising:
a control circuit board;
a power supply configured for supplying power;
a capacitive human body induction sensor configured for sensing that a human body approaches the hanging accessory for night lighting,
an environmental light intensity sensor configured for detecting an environmental light intensity, and
a light emitting diode lamp configured for night lighting;
wherein a cavity for accommodating the plurality of electrical elements is formed between the front housing and the rear housing; and wherein the power supply, the capacitive human body induction sensor, the environmental light intensity sensor and light emitting diode lamp are connected to the control circuit board separately.

9. The hanging accessory for night lighting according to claim 8, wherein the plurality of electrical elements further comprises a motion switch configured for detecting a fall of a human body, and a beeping alarm configured for alarming when the motion switch is triggered; and wherein the motion switch and the beeping alarm are connected to the control circuit board separately.

10. The hanging accessory for night lighting according to claim 8, wherein the control circuit board is provided with an adjusting device for adjusting sensitivity of the capacitive human body induction sensor.

11. The hanging accessory for night lighting according to claim 8, wherein the main body part has a cartoon design.

12. The hanging accessory for night lighting according to claim 8, wherein the environmental light intensity sensor is a photoresistor.

13. The hanging accessory for night lighting according to claim 8, wherein the environmental light intensity sensor is a photoelectric triode.

14. The hanging accessory for night lighting according to claim 8, wherein the clamping component is a clamp with elasticity.

15. The hanging accessory for night lighting according to claim 8, wherein the LED lamp is a white LED.
